(19) United States
(12) Patent Application Publication
(10) Pub. No.: US 2025/0366656 A1
(43) Pub. Date: Dec. 4, 2025

(54) INDUCTION CAPABLE COOKWARE ITEM COMPRISING WOVEN WIRE OR KNITTED MESH IN ITS BASE

(71) Applicant: APOLLO TOPCO BV, Gent (BE)

(72) Inventor: Gabriele CORBANI, Soncino (CR) (IT)

(73) Assignee: APOLLO TOPCO BV, Gent (BE)

(21) Appl. No.: 18/870,920

(22) PCT Filed: Jun. 2, 2023
(86) PCT No.: PCT/EP2023/064873

§ 371 Date: Dec. 2, 2024

(30) Foreign Application Priority Data
Jun. 3, 2022 (BE) 2022/5435

(51) Int. Cl. A47J 36/02; A47J 27/00

(52) U.S. Cl. CPC A47J 36/02; A47J 27/002

(57) ABSTRACT

The invention provides in an induction capable cookware item, comprising:—a base, mainly made from aluminium or an aluminium alloy;—a side wall, extending upwards from said base; wherein the base and the side wall form a vessel, thereby defining:—an exterior side of the vessel, the base and the side wall; and,—an interior side of the vessel the base and the side wall; wherein the base comprises a woven wire mesh or knitted wire mesh, preferably a woven wire mesh; and, wherein the base comprises protrusions on the exterior side. The invention further provides in a method for making such induction capable cookware item, and in the use of a woven wire mesh as induction element in a base of cookware item, preferably an aluminium cookware item.

### FIELD OF THE INVENTION

The present invention relates to the technical field of cookware, and more in particular induction capable cookware, more particularly made mainly from aluminium.

### BACKGROUND OF THE INVENTION

To make aluminium cookware capable to be used on induction, in the art expanded metal lath is added in the base of the cookware item. However, this has disadvantage that the expanded metal lath, suffers from a shape memory, which after heating up of the cookware item, results in shrinkage in mainly one direction. This result in a deformation of the base of the cookware item. Often such bases tend to roll up, resulting in a cookware item, that starts to rock on the heating plate and/or does not make sufficient contact with the heating plate. The deformation of the base may also lead to cracks in the coating on the cookware item, or in cracks between the base and the side wall of the cookware item. Often this tendency to deformation is compensated by providing a tick base, which may be better in resisting the deformation. However, there is a demand for light-weight cookware items, which resist deformation upon use, and preferably which resist cracking of the coating upon use.

Even a perforated plate, which is sometimes added to the base of a cookware item, has a shape memory, originating in its production method. On top of that, because the plate is monolithic, it cannot respond well to uneven expansion and shrinkage.

Even more, the introduction of an expanded metal lath or a perforated plate in the base is challenging; specially to cover it completely in aluminium, as these need a very high moulding-pressure during fabrication to be integrated in the base. Because of these challenging conditions during manufacturing, a lot of defects occur.

### SUMMARY OF THE INVENTION

It has now surprisingly been found that some or all of the above demands and objectives can be attained either individually or in any combination by providing a woven wire mesh in the base of a cookware item.

In particular, the present invention relates to an induction capable cookware item, comprising:
a base;
a side wall, extending upwards from said base;
wherein the base comprises a woven wire mesh or knitted wire mesh, preferably a woven wire mesh.

In some embodiments, the base and the side wall form a vessel, thereby defining:
an exterior side of the vessel, the base and the side wall; and,
an interior side of the vessel the base and the side wall.

More particular, the present invention may provide in an induction capable cookware item, comprising:
a base, mainly made from aluminium or an aluminium alloy;
a side wall, extending upwards from said base;
wherein the base and the side wall form a vessel, thereby defining:
an exterior side of the vessel, the base and the side wall; and,
an interior side of the vessel the base and the side wall;
wherein the base comprises a woven wire mesh or knitted wire mesh, preferably a woven wire mesh; and,
wherein the base comprises protrusions on the exterior side;
preferably, wherein the woven or knitted wire mesh is completely encased by the base; and/or,
preferably, wherein the base and the protrusion are monolithic.

In some embodiments, the average cross-section of the protrusions is larger than the average opening in the woven or knitted wire mesh.

Further, in some embodiments, the woven or knitted wire mesh is completely encased by the aluminium or the aluminium alloy of the base.

In some embodiments, the cookware item comprises:
a base, mainly made from aluminium or an aluminium alloy;
a side wall, mainly made from aluminium or an aluminium alloy; and extending upwards from said base;
wherein the base comprises a woven wire mesh or a knitted wire mesh; preferably a woven wire mesh, preferably a woven or knitted ferrous metal wire mesh, preferably a woven or knitted steel wire mesh.

In some embodiments, the woven wire mesh is crimped woven wire mesh, preferably double crimped woven wire mesh.

In some embodiments, the woven wire mesh is an open weave.

In some embodiments, the average opening in the weave is larger than, preferably least 2.0 times larger than, preferably least 3.0 times larger than, preferably least 4.0 times larger than, preferably least 5.0 times larger than the cross-section of the wire.

In some embodiments, the cookware item is forged.

In some embodiments, the base comprises protrusions on the exterior side.

In some embodiments, the protrusions are aluminium or aluminium alloy protrusions.

In some embodiments, the protrusions are circular, spherical caps, spherical segments or cylindrical, preferably cylindrical.

In some embodiments, the height of the protrusions is less than the diameter of the protrusion.

In some embodiments, the average cross-section of the protrusions is larger than the average opening in the woven or knitted wire mesh, preferably larger than two times, preferably larger than three times, preferably larger than at least four times, preferably larger than five times, preferably larger than seven times, preferably larger than ten times, the average opening in the woven or knitted wire mesh.

In some embodiments, the woven or knitted wire mesh extends throughout at least 50%, preferably at least 60%, preferably at least 70%, preferably at least 80%, preferably at least 90%, preferably at least 95%, preferably at least 98%, preferably at least 99% of the base; preferably the surface area of the base.

The invention further provides in a method for manufacturing an induction capable cookware item, comprising the steps of:
providing an aluminium or aluminium alloy disk with a first diameter (d1);
providing a disk of a woven or knitted wire mesh, preferably a disk of a woven wire mesh, with a second diameter (d2), wherein the second diameter is smaller than the first diameter (d2<d1);
concentrically aligning the aluminium or aluminium alloy disk and the disk of woven or knitted wire mesh over a cookware mould;
forging the aligned aluminium or aluminium alloy disk and the disk of woven or knitted wire mesh in the mould, thereby:
   forming a cookware item comprising a base and a side wall extending upwards from the base; and,
   integrating the woven or knitted wire mesh in the base.

More particular, the invention may provide in a method for manufacturing an induction capable cookware item, comprising the steps of:
providing an aluminium or aluminium alloy disk with a first diameter (d1);
providing a disk of a woven or knitted wire mesh, preferably a disk of a woven wire mesh, with a second diameter (d2), wherein the second diameter is smaller than the first diameter (d2<d1);
concentrically aligning the aluminium or aluminium alloy disk and the disk of woven or knitted wire mesh over a cookware mould;
forging the aligned aluminium or aluminium alloy disk and the disk of woven or knitted wire mesh in the mould, thereby:
   forming a cookware item comprising a base and a side wall extending upwards from the base; and,
   integrating the woven or knitted wire mesh completely in the base, preferably completely in the aluminium or aluminium alloy of the base.

The invention further provides in the use of a woven or knitted wire mesh, preferably a woven wire mesh, as induction element in a base of cookware item.

More particular, the invention may provide in the use of a crimped woven wire mesh, preferably a double crimped woven wire mesh, as induction element in a base of cookware item.

The independent and dependent claims set out particular and preferred features of the invention. Features from the dependent claims may be combined with features of the independent or other dependent claims as appropriate.

The present invention will now be further described. In the following passages, different aspects of the invention are defined in more detail. Each aspect so defined may be combined with any other aspect or aspects unless clearly indicated to the contrary. In particular, any feature or statement indicated as being preferred or advantageous may be combined with any other features or statements indicated as being preferred or advantageous.

### BRIEF DESCRIPTION OF THE FIGURES

FIG. 1a and FIG. 1b depict an induction capable cookware item (1) according to an embodiment of the invention.

FIG. 2a and FIG. 2b depict an induction capable cookware item (1) according to an embodiment of the invention.

FIG. 3a and FIG. 3b depict an induction capable cookware item (1) according to an embodiment of the invention.

FIG. 4 provides a render of an induction capable cookware item (1) according to an embodiment of the invention.

### DETAILED DESCRIPTION OF THE INVENTION

When describing the invention, the terms used are to be construed in accordance with the following definitions, unless a context dictates otherwise.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims and statements, any one of the embodiments can be used in any combination.

The terms “comprising”, “comprises” and “comprised of” as used herein are synonymous with “including”, “includes” or “containing”, “contains”, and are inclusive or open-ended and do not exclude additional, non-recited members, elements, or method steps. It will be appreciated that the terms “comprising”, “comprises” and “comprised of” as used herein comprise the terms “consisting of”, “consists” and “consists of”.

As used in the specification and the appended claims, the singular forms “a”, “an,” and “the” include plural referents unless the context clearly dictates otherwise. By way of example, “a step” means one step or more than one step.

Unless defined otherwise, all technical and scientific terms used herein have the same meaning as is commonly understood by one of skill in the art.

The recitation of numerical ranges by endpoints includes all integer numbers and, where appropriate, fractions subsumed within that range (e.g., 1 to 5 can include 1, 2, 3, 4 when referring to, for example, a number of elements, and can also include 1.5, 2, 2.75 and 3.80, when referring to, for example, measurements). The recitation of endpoints also includes the end point values themselves (e.g., from 1.0 to 5.0 includes both 1.0 and 5.0). Any numerical range recited herein is intended to include all sub-ranges subsumed therein.

The term “about” as used herein when referring to a measurable value such as a parameter, an amount, a temporal duration, and the like, is meant to encompass variations of +/−10% or less, preferably +/−5% or less, more preferably +/−1% or less, of and from the specified value, insofar such variations are appropriate to perform in the disclosed invention. It is to be understood that the value to which the modifier “about” refers is itself also specifically, and preferably, disclosed.

The terms “wt %”, “vol %”, or “mol %” refers to a weight percentage of a component, a volume percentage of a component, or molar percentage of a component, respectively, based on the total weight, the total volume of material, or total moles, that includes the component.

When describing the present invention, the terms used are to be construed in accordance with the following definitions, unless a context dictates otherwise.

Preferred statements (features) and embodiments and uses of this invention are set herein below. Each statement and embodiment of the invention so defined may be combined with any other statement and/or embodiment unless clearly indicated to the contrary. In particular, any feature indicated as being preferred or advantageous may be combined with any other feature or features or statements indicated as being preferred or advantageous. Hereto, the present invention is in particular captured by any one or any combination of one or more of the below numbered statements and embodiments, with any other aspect and/or embodiment.
1. An induction capable cookware item, comprising:
   a base;
   a side wall, extending upwards from said base;
wherein the base comprises a woven wire mesh or knitted wire mesh, preferably a woven wire mesh.
2. The cookware item according to statement 1, wherein the base and the side wall form a vessel, thereby defining:
an exterior side of the vessel, the base and the side wall; and,
   an interior side of the vessel the base and the side wall.
3. The cookware item according to statement 1 or 2, comprising:
   a base, made from aluminium or an aluminium alloy;
   a side wall, made from aluminium or an aluminium alloy, extending upwards from said base;
wherein the base comprises a woven wire mesh or a knitted wire mesh; preferably a woven wire mesh, preferably a woven or knitted ferrous metal wire mesh, preferably a woven or knitted steel wire mesh.
4. The cookware item according to any one of previous statements, comprising:
   a base, mainly made from aluminium or an aluminium alloy;
   a side wall, extending upwards from said base;
wherein the base and the side wall form a vessel, thereby defining:
   an exterior side of the vessel, the base and the side wall; and,
   an interior side of the vessel the base and the side wall;
wherein the base comprises a woven wire mesh or knitted wire mesh, preferably a woven wire mesh; and,
wherein the base comprises protrusions on the exterior side.
5. The cookware item according to any one of the previous statements, wherein the average cross-section of the protrusion is larger than the average opening in the woven or knitted wire mesh.
6. The cookware item according to any one of previous statements, wherein the woven or knitted wire mesh is completely encased by the base.
7. The cookware item according to any one of previous statements, wherein the protrusions are aluminium or aluminium alloy protrusions.
8. The cookware item according to any one of previous statements, wherein the base and the protrusion are monolithic.
9. The cookware item according to any one of previous statements, wherein the protrusions are aluminium or aluminium alloy protrusions.
10. The cookware item according to any one of previous statements, wherein the wire of the woven wire mesh is a steel wire, preferably a stainless-steel wire, preferably a AISI 430 wire.
11. The cookware item according to any one of previous statements, wherein the woven wire mesh is crimped woven wire mesh, preferably double crimped woven wire mesh.
12. The cookware item according to any one of previous statements, wherein the woven wire mesh is wire cloth.
13. The cookware item according to any one of previous statements, wherein the woven wire mesh is a plain weave.
14. The cookware item according to any one of previous statements, wherein the woven wire mesh is an open weave.
15. The cookware item according to any one of previous statements, wherein the woven wire mesh is printed.
16. The cookware item according to any one of previous statements, wherein the average opening (surface of each opening) in the weave are larger than, preferably least 2.0 times larger than, preferably least 3.0 times larger than, preferably least 4.0 times larger than, preferably least 5.0 times larger than the cross-section of the wire.
17. The cookware item according to any one of previous statements, wherein the opening is the woven wire mesh are square.
18. The cookware item according to any one of previous statements, wherein the base and/or side wall comprises aluminium or an aluminium alloy.
19. The cookware item according to any one of previous statements, wherein the base and/or side wall are mainly aluminium or an aluminium alloy.
20. The cookware item according to any one of previous statements, wherein the cookware item is forged.
21. The cookware item according to any one of previous statements, wherein the woven or knitted wire mesh is foraged into the base, preferably from the exterior side.
22. The cookware item according to any one of previous statements, wherein the base comprises protrusions on the exterior side.
23. The cookware item according to any one of previous statements, wherein the protrusions are circular, spherical caps, spherical segments or cylindrical.
24. The cookware item according to any one of previous statements, wherein the protrusions comprise a flat surface.
25. The cookware item according to any one of previous statements, wherein the protrusions comprise a surface parallel to the surface of the base.
26. The cookware item according to any one of previous statements, wherein the height of the protrusion is less than the largest diameter of the protrusion.
27. The cookware item according to any one of previous statements, wherein the protrusions are arranged on the base in a pattern, preferably a geometric pattern.
28. The cookware item according to any one of previous statements, wherein the protrusions are laid out in concentric circles or concentric polygons, such as concentric hexagons.
29. The cookware item according to any one of previous statements, wherein the average cross-section of the protrusions is larger than the average openings in the woven or knitted wire mesh.
30. The cookware item according to any one of previous statements, wherein each protrusion comprises more than one repetitive unit of the woven or knitted wire mesh.
31. The cookware item according to any one of previous statements, wherein the base has a thickness of at least 2.0 mm, preferably at least 2.5 mm, preferably at least 3.0 mm, preferably at least 3.5 mm, preferably at least 4.0 mm.

32. The cookware item according to any one of previous statements, wherein the base has a thickness of at most 10.0 mm, preferably at most 8.0 mm, preferably at most 6.0 mm, preferably at most 5.0 mm, preferably at most 4.5 mm.
33. The cookware item according to any one of previous statements, wherein the thickness of the wire is at least 0.1 mm to at most 2.0 mm, preferably at least 0.2 mm to at most 1.5 mm, preferably at least 0.3 mm to at most 1.0 mm, preferably at least 0.4 mm to at most 0.7 mm, preferably at least 0.5 mm to at most 0.6 mm.
34. The cookware item according to any one of previous statements, wherein the thickness of the wire is at least 0.1 mm, preferably at least 0.2 mm, preferably at least 0.3 mm, preferably at least 0.4 mm, preferably at least 0.5 mm.
35. The cookware item according to any one of previous statements, wherein the thickness of the wire is at most 2.0 mm, preferably at most 1.5 mm, preferably at most 1.0 mm, preferably at most 0.7 mm, preferably at most 0.6 mm.
36. The cookware item according to any one of previous statements, wherein the shortest distance between two consecutive intersections in the woven or knitted wire mesh is at least 1.0 mm to at most 10.0 mm, preferably at least 2.0 mm to at most 9.0 mm, preferably at least 3.0 mm to at most 8.0 mm, preferably at least 4.0 mm to at most 7.0 mm, preferably at least 5.0 mm to at most 6.0 mm.
37. The cookware item according to any one of previous statements, wherein the shortest distance between two consecutive intersections in the woven or knitted wire mesh is at least 1.0 mm, preferably at least 2.0 mm, preferably at least 3.0 mm, preferably at least 4.0 mm, preferably at least 5.0 mm.
38. The cookware item according to any one of previous statements, wherein the shortest distance between two consecutive intersections in the woven wire or knitted mesh is at most 10.0 mm, preferably at most 9.0 mm, preferably at most 8.0 mm, preferably at most 7.0 mm, preferably at most 6.0 mm.
39. The cookware item according to any one of previous statements, wherein the longest distance between two consecutive intersections in the woven or knitted wire mesh is at least 1.0 mm to at most 10.0 mm, preferably at least 2.0 mm to at most 9.0 mm, preferably at least 3.0 mm to at most 8.0 mm, preferably at least 4.0 mm to at most 7.0 mm, preferably at least 5.0 mm to at most 6.0 mm.
40. The cookware item according to any one of previous statements, wherein the longest distance between two consecutive intersections in the woven or knitted wire mesh is at least 1.0 mm, preferably at least 2.0 mm, preferably at least 3.0 mm, preferably at least 4.0 mm, preferably at least 5.0 mm.
41. The cookware item according to any one of previous statements, wherein the longest distance between two consecutive intersections in the woven or knitted wire mesh is at most 10.0 mm, preferably at most 9.0 mm, preferably at most 8.0 mm, preferably at most 7.0 mm, preferably at most 6.0 mm.
42. The cookware item according to any one of previous statements, wherein the base is concave, comparative to the exterior side of the base.
43. The cookware item according to any one of previous statements, wherein the cookware item is coated.
44. The cookware item according to any one of previous statements, wherein the interior side of the cookware item is coated with a non-stick coating.
45. The cookware item according to any one of previous statements, wherein the cookware item is a pot or a pan, preferably a pan, preferably a frying pan.
46. The cookware item according to any one of previous statements, wherein one or more handles are attached to the exterior side of the side wall.
47. The cookware item according to any one of previous statements, wherein the woven or knitted wire mesh extends throughout at least 50%, preferably at least 60%, preferably at least 70%, preferably at least 80%, preferably at least 90%, preferably at least 95%, preferably at least 98%, preferably at least 99% of the base; preferably the surface area of base.
48. A method for manufacturing an induction capable cookware item, comprising the steps of:
   providing an aluminium or aluminium alloy disk with a first diameter (d1);
   providing a disk of a woven or knitted wire mesh, preferably a disk of a woven wire mesh, with a second diameter (d2), wherein the second diameter is smaller than the first diameter (d2<d1);
   concentrically aligning the aluminium or aluminium alloy disk and the disk of woven or knitted wire mesh over a cookware mould;
   forging the aligned aluminium or aluminium alloy disk and the disk of woven or knitted wire mesh in the mould, thereby:
      forming a cookware item comprising a base and a side wall extending upwards from the base; and,
      integrating the woven or knitted wire mesh in the base.
49. The method according to statement 40, wherein the mould comprises a base section and a side wall section.
50. The method according to statement 40 or 41, wherein the mould comprises indentations in the base section, resulting in protrusions in the base of the cookware item.
51. The method according to any one of statements 40 to 42, wherein the second diameter is equal to or smaller than the diameter of the base section of the mould.
52. The method according to any one of statements 40 to 43, wherein the pressure applied during forging is at least 1000 tons, preferably at least 1500 tons, preferably at least 2000 tons, preferably at least 2500 tons, preferably at least 3000 tons, preferably at least 3500 tons, preferably at least 4000 tons, preferably at least 4200 tons.
53. The method according to any one of statements 40 to 44, wherein concentrically aligning the aluminium or aluminium alloy disk and the disk of woven or knitted wire mesh involves attaching the two disks to each other, preferably by spotwelding.
54. Use of a woven or knitted wire mesh, preferably a woven wire mesh, as induction element in a base of cookware item.
55. Use according to statement 46, wherein the base of the cookware item is mainly aluminium or an aluminium alloy.
56. Use according to statement 46 or 47, wherein the wire of the woven or knitted wire mesh is a ferrous metal.

The present invention is based on the finding that a woven or knitted wire mesh in the base of a cookware item provides a base which does not easily deforms upon heating. This allows for a thin base and a lightweight cookware item. The woven or knitted wire mesh can be easily integrated into the base, and results in a smooth bottom surface. This smooth surface has the advantage that it can be easily coated or painted.

As used herein, the term “woven wire mesh” should be understood as a two-dimensional or three-dimensional lattices made from two or more metallic wires which are linked to one another by weaving. Preferably, the woven wire mesh should be understood are two layers of wires that are interwoven, i.e. under and over one another. Preferably, the intersections of the wires in the woven wore mesh are free, meaning that they are not welded, not soldered, not sintered, or not physically bonded to each other any other way.

As used herein, the term “knitted wire mesh” should be understood as a three-dimensional lattices made from two or more metallic wires which are linked to one another by knitting.

The present invention relates to an induction capable cookware item, comprising:
a base;
a side wall, extending upwards from said base;
wherein the base comprises a woven wire mesh or knitted wire mesh, preferably a woven wire mesh.

In particular, the invention provides in an induction capable cookware item, comprising:
a base;
a side wall, extending upwards from said base;
wherein the base comprises a woven wire mesh. The woven wire mesh can be thinner compared to a knitted wire mesh made with the same diameter of wire.

Such cookware has the advantage that the woven wire mesh can be easily integrated into the base, for example by forging and avoids deformation upon heating of the cookware item.

More in particular, the invention provides in an induction capable cookware item, comprising:
a base, made from aluminium or an aluminium alloy;
a side wall, made from aluminium or an aluminium alloy, extending upwards from said base;
wherein the base comprises a woven wire mesh, preferably a woven steel wire mesh.

The steel wire mesh makes the otherwise manly aluminium cookware suitable for induction, while the woven element of the steel mesh avoids deformation upon heating, as the woven element avoids shape memory in a single direction of the mesh, thereby avoiding unequal expansion and/or shrinkage in different directions.

In some embodiments, the base and the side wall form a vessel, thereby defining:
an exterior side of the vessel, the base and the side wall; and,
an interior side of the vessel the base and the side wall.

More particular, the present invention may provide in an induction capable cookware item, comprising:
a base, mainly made from aluminium or an aluminium alloy;
a side wall, extending upwards from said base;
wherein the base and the side wall form a vessel, thereby defining:
an exterior side of the vessel, the base and the side wall; and,
an interior side of the vessel the base and the side wall;
wherein the base comprises a woven wire mesh or knitted wire mesh, preferably a woven wire mesh; and,
wherein the base comprises protrusions on the exterior side;
preferably, wherein the woven or knitted wire mesh is completely encased by the base; and/or,
preferably, wherein the base and the protrusion are monolithic.

In some embodiments, the average cross-section of the protrusions is larger than the average opening in the woven or knitted wire mesh.

In some embodiments, the woven or knitted wire mesh is completely encased by the aluminium or the aluminium alloy of the base.

In some embodiments, the wire of the woven or knitted wire mesh is a steel wire, preferably a stainless-steel wire, preferably ferritic stainless-steel wire or martensitic stainless-steel wire, preferably ferritic stainless-steel wire.

In some embodiments, the wire of the woven or knitted wire mesh is a ferrous metal.

In some embodiments, the wire of the woven or knitted wire mesh is a AISI 409, AISI 430, AISI 439, AISI 410, AISI 420, AISI 440 wire, preferably AISI 409, AISI 430, AISI 439 wire, preferably AISI 430 wire.

In some embodiments, the woven wire mesh is crimped woven wire mesh, preferably double crimped woven wire mesh. The crimping provides a stability to the mesh, whiteout physically bonding the wires together on the intersections. This way movement between the different wires in the mesh can occur, which reduces tension in the mesh and base upon heating, thereby providing a more dimensional stable base of the cookware item.

In some embodiments, the woven wire mesh is wire cloth. A wire cloth does not have physical bonded intersections between the wires, thereby allowing movement between the wires avoiding tension and deformation upon heating.

In some embodiments, the woven wire mesh is a plain weave. The plain weave has the advantage that there are a lot of intersections between the wires in the weft and warp direction, thereby providing a stable mesh.

In some embodiments, the woven wire mesh is an open weave. The openings in the weave, i.e. the openings between two consecutive wires, can be used to allow aluminium to flow through, upon fabrication. This results in an extremely intense bond between the woven wire mesh and the base. In some embodiment, this may allow the woven wire mesh to be completely encased into the base of the

In some embodiments, the average opening (surface of each opening) in the weave are larger than, preferably least 2.0 times larger than, preferably least 3.0 times larger than, preferably least 4.0 times larger than, preferably least 5.0 times larger than the cross-section of the wire.

In some embodiments, the base and/or side wall comprises aluminium or an aluminium alloy. In some embodiments, the base and/or side wall are mainly aluminium or an aluminium alloy.

In some embodiment, the aluminium m alloy is selected from the list comprising Alloy 4006, Alloy 1200, Alloy 1050, and 3104 g recycled aluminium.

In some embodiments, the cookware item is forged. This has the advantage that seamless cookware items can be obtained, yet comprising sharp corners and edges. Forging allows for a good incorporation of the woven or knitted wire mesh in the base of the cookware item, and preferably leaving smooth surfaces, that can easily painted and coated, and whereto the coating or paint adheres very well even after repetitive use of the cookware.

In some embodiments, the woven or knitted wire mesh is foraged into the base, preferably from the exterior side. In some embodiments, the woven wire mesh is contained in the lower half of the base.

In some embodiments, the woven or knitted wire mesh is completely encased by the base. This avoids that the surface of the base is made from two materials, what is beneficial when a coating is applied, avoiding seems and cracks. In some embodiments, the woven or knitted wire mesh is complete encasing by the aluminium or aluminium alloy of the base. Such complete encasing may prevent oxidation or corrosion of the woven or knitted wire mesh.

Due the production method, such as forging, the position of the woven or knitted wire mesh in the aluminium or aluminium alloy of the base, may be visible as the surface of the aluminium or aluminium alloy may be deformed during the production process. However, a complete encapsulation of the woven or knitted wire mesh may be achieved.

In some embodiments, the base comprises protrusions on the exterior side. These protrusions stabilize the base form deforming irreversibly, as the ridges and edges of the protrusions provide mechanical strength to the base.

In some embodiments, the protrusions are circular, spherical caps, spherical segments or cylindrical, preferably cylindrical. These round shapes have the advantage that they provide the mechanical stability in every direction (in the 2D field of the base).

In some embodiments, the protrusions comprise a flat surface. The flat surface may be used to contact the cooker or the heat source, which may provide a better heat conductivity. In some embodiments, the protrusions comprise a surface parallel to the surface of the base.

In some embodiments, the height of the protrusion less than the largest diameter of the protrusion. In some embodiments, the diameter of the protrusion is at least 2.0 times, preferably at least 3.0 times, preferably at least 4.0 times, preferably at least 5.0 times, preferably at least 6.0 times, preferably at least 8.0 times, preferably at least 10.0 times, the height of the protrusion.

In some embodiments, the diameter of the protrusion is measured at the basis of the protrusion, i.e. the transition between the base and the protrusion.

In some embodiments, the protrusions are arranged on the base in a pattern, preferably a geometric pattern. These patterns may provide mechanical strength along edges and ridges in the pattern.

In some embodiments, the protrusions are laid out in concentric circles or concentric polygons, such as concentric hexagons, preferably concentric regular hexagons. The lines, ridges or edges defined by the hexagons may provide mechanical strength.

In some embodiments, the protrusions do not touch each other. In some embodiments, the protrusions are spaced out from each other. In some embodiments, the distance between two neighbouring protrusions is at least equal to the height of the protrusion, preferably at least 2.0 times the height of the protrusion, preferably at least 3.0 times the height of the protrusion.

In some embodiments, the average cross-section of the protrusions is larger than the average opening in the woven or knitted wire mesh. In some embodiments, the average cross-section of the protrusions is larger than at least 2, preferably at least 3, preferably at least 4, preferably at least 5, preferably at least 6, preferably at least 7, preferably at least 8, preferably at least 9 2D repetitive units of the woven or knitted wire mech. This has the advantage each protrusion comprises or covers more than one repetitive unit of the woven or knitted wire mesh, resulting in a good heat production and heat transfer within the protrusion, on inductions heat plates.

In some embodiments, each protrusion comprises more than one repetitive unit of the woven or knitted wire mesh.

In some embodiments, the height of the protrusions is at least 0.1 mm to at most 2.0 mm, preferably at least 0.2 mm to at most 1.5 mm, preferably at least 0.3 mm to at most 1.0 mm, preferably at least 0.4 mm to at most 0.9 mm, preferably at least 0.5 mm to at most 0.8 mm.

In some embodiments, the height of the protrusions is at least 0.1 mm, preferably at least 0.2 mm, preferably at least 0.3 mm, preferably at least 0.4 mm, preferably at least 0.5 mm, preferably at least 0.6 mm, preferably at least 0.7 mm, preferably at least 0.8 mm.

In some embodiments, the height of the protrusions is at most 2.0 mm, preferably at most 1.5 mm, preferably at most 1.0 mm, preferably at most 0.9 mm, preferably at most 0.9 mm.

In some embodiments, the base has a thickness of at least 2.0 mm, preferably at least 2.5 mm, preferably at least 3.0 mm, preferably at least 3.5 mm, preferably at least 4.0 mm. Preferably, the thickness of the base is measured including the height of protrusions, if present.

In some embodiments, the base has a thickness of at most 10.0 mm, preferably at most 8.0 mm, preferably at most 6.0 mm, preferably at most 5.0 mm, preferably at most 4.5 mm.

In some embodiments, the thickness of the wire is at least 0.1 mm to at most 2.0 mm, preferably at least 0.2 mm to at most 1.5 mm, preferably at least 0.3 mm to at most 1.0 mm, preferably at least 0.4 mm to at most 0.7 mm, preferably at least 0.5 mm to at most 0.6 mm.

In some embodiments, the thickness of the wire is at least 0.1 mm, preferably at least 0.2 mm, preferably at least 0.3 mm, preferably at least 0.4 mm, preferably at least 0.5 mm.

In some embodiments, the thickness of the wire is at most 2.0 mm, preferably at most 1.5 mm, preferably at most 1.0 mm, preferably at most 0.7 mm, preferably at most 0.6 mm.

In some embodiments, the shortest distance between two consecutive intersections in the woven or knitted wire mesh is at least 1.0 mm to at most 10.0 mm, preferably at least 2.0 mm to at most 9.0 mm, preferably at least 3.0 mm to at most 8.0 mm, preferably at least 4.0 mm to at most 7.0 mm, preferably at least 5.0 mm to at most 6.0 mm.

In some embodiments, wherein the shortest distance between two consecutive intersections in the woven wire or knitted mesh is at least 1.0 mm, preferably at least 2.0 mm, preferably at least 3.0 mm, preferably at least 4.0 mm, preferably at least 5.0 mm.

In some embodiments, the shortest distance between two consecutive intersections in the woven or knitted wire mesh is at most 10.0 mm, preferably at most 9.0 mm, preferably at most 8.0 mm, preferably at most 7.0 mm, preferably at most 6.0 mm.

In some embodiments, the longest distance between two consecutive intersections in the woven or knitted wire mesh is at least 1.0 mm to at most 10.0 mm, preferably at least 2.0 mm to at most 9.0 mm, preferably at least 3.0 mm to at most 8.0 mm, preferably at least 4.0 mm to at most 7.0 mm, preferably at least 5.0 mm to at most 6.0 mm.

In some embodiments, the longest distance between two consecutive intersections in the woven or knitted wire mesh is at least 1.0 mm, preferably at least 2.0 mm, preferably at least 3.0 mm, preferably at least 4.0 mm, preferably at least 5.0 mm.

In some embodiments, the longest distance between two consecutive intersections in the woven or knitted wire mesh is at most 10.0 mm, preferably at most 9.0 mm, preferably at most 8.0 mm, preferably at most 7.0 mm, preferably at most 6.0 mm.

In some embodiments, the base comprises a protruding ring along the edge, preferably is the ring protruding from the base with the same height of the protrusions. Such a ring provides the contact surface with the heat plate even when the base expands convexly, thereby preventing rocking of the cookware item on the heat plate. The ring may be used as a surface for printing, such as screen printing.

In some embodiments, the base comprises a central protrusion, wherein the cross-section central protrusion is at least 2 times, preferably at least 3 times, preferably at least 4 times, preferably at least 5 times, preferably at least 6 times, preferably at least 8 times, preferably at least 10 times the average cross-section of the other protrusions. Preferably, the cross-sections being measured at the basis of the protrusions. Preferably, the central protrusion has the same height as the other protrusions. Preferably, the central protrusion has the same shape as the other protrusions. The central protrusion may be used as a surface for printing, such as screen printing.

In some embodiments, the base is concave, judged from the exterior side of the base. This provides a preferred direction of expansion upon heating towards a more concave shape. This avoids the base form becoming convex upon heating, which would result in a cookware item that rocks on the heat plate.

In some embodiments, the cookware item is coated. In some embodiments, the interior side of the cookware item is coated with a non-stick coating. Coatings such as Thermolon® by GreenPan or polytetrafluoroethylene (PTFE) coating.

In some embodiments, the cookware item is a pot or a pan, preferably a pan, preferably a frying pan.

In particular embodiments, the induction capable cookware item, may comprise:
a base, mainly made from aluminium or an aluminium alloy;
a side wall, extending upwards from said base;
wherein the base and the side wall form a vessel, thereby defining:
an exterior side of the vessel, the base and the side wall; and,
an interior side of the vessel the base and the side wall;
wherein the base comprises a woven wire mesh or knitted wire mesh, preferably a woven wire mesh;
wherein the base comprises protrusions on the exterior side; and,
wherein the woven or knitted wire mesh is completely encased by the base.

The invention further provides in a method for manufacturing an induction capable cookware item, comprising the steps of:
providing an aluminium or aluminium alloy disk with a first diameter (d1);
providing a disk of a woven or knitted wire mesh, preferably a disk of a woven wire mesh, with a second diameter (d2), wherein the second diameter is smaller than the first diameter (d2<d1);
concentrically aligning the aluminium or aluminium alloy disk and the disk of woven or knitted wire mesh over a cookware mould;
forging the aligned aluminium or aluminium alloy disk and the disk of woven or knitted wire mesh in the mould, thereby:
   forming a cookware item comprising a base and a side wall extending upwards from the base; and,
   integrating the woven or knitted wire mesh in the base.

In particular, the invention provides in a method for manufacturing an induction capable cookware item, comprising the steps of:
providing an aluminium or aluminium alloy disk with a first diameter (d1);
providing a disk of a woven wire mesh with a second diameter (d2), wherein the second diameter is smaller than the first diameter (d2<d1);
concentrically aligning the aluminium or aluminium alloy disk and the disk of woven wire mesh over a cookware mould;
forging the aligned aluminium or aluminium alloy disk and the disk of woven wire mesh in the mould, thereby:
   forming a cookware item comprising a base and a side wall extending upwards from the base; and,
   integrating the woven wire mesh in the base.

More particular, the invention may provide in a method for manufacturing an induction capable cookware item, comprising the steps of:
providing an aluminium or aluminium alloy disk with a first diameter (d1);
providing a disk of a woven or knitted wire mesh, preferably a disk of a woven wire mesh, with a second diameter (d2), wherein the second diameter is smaller than the first diameter (d2<d1);
concentrically aligning the aluminium or aluminium alloy disk and the disk of woven or knitted wire mesh over a cookware mould;
forging the aligned aluminium or aluminium alloy disk and the disk of woven or knitted wire mesh in the mould, thereby:
   forming a cookware item comprising a base and a side wall extending upwards from the base; and,
   integrating the woven or knitted wire mesh completely in the base, preferably completely in the aluminium or aluminium alloy of the base.

In some embodiments, the method is suitable for manufacturing an induction capable cookware item according to an embodiment described herein.

In some embodiments, the mould comprises a base section and a side wall section.

In some embodiments, the mould comprises indentations in the base section, resulting in protrusions in the base of the cookware item.

In some embodiments, the second diameter is equal to or smaller than the diameter of the base section of the mould.

In some embodiments, the pressure applied during forging is at least 1000 tons, preferably at least 1500 tons, preferably at least 2000 tons, preferably at least 2500 tons, preferably at least 3000 tons, preferably at least 3500 tons, preferably at least 4000tons, preferably at least 4200 tons.

In some embodiments, concentrically aligning the aluminium or aluminium alloy disk and the disk of woven or knitted wire mesh involves attaching the two disks to each other, preferably by spotwelding.

The invention further provides in the use of a woven or knitted wire mesh, preferably a woven wire mesh, as induction element in a base of cookware item.

More particular, the invention may provide in the use of a crimped woven wire mesh, preferably a double crimped woven wire mesh, as induction element in a base of cookware item.

In particular, the invention provides in the use of a woven wire mesh as induction element in a base of

In some embodiments, the base of the cookware item is mainly aluminium or an aluminium alloy.

In some embodiments, the wire of the woven or knitted wire mesh is a ferrous metal.

The following examples serve to merely illustrate the invention and should not be construed as limiting its scope in any way. While the invention has been shown in only some of its forms, it should be apparent to those skilled in the art that it is not so limited, but is susceptible to various changes and modifications without departing from the scope of the invention due to over-tightening.

### EXAMPLES

### Example 1

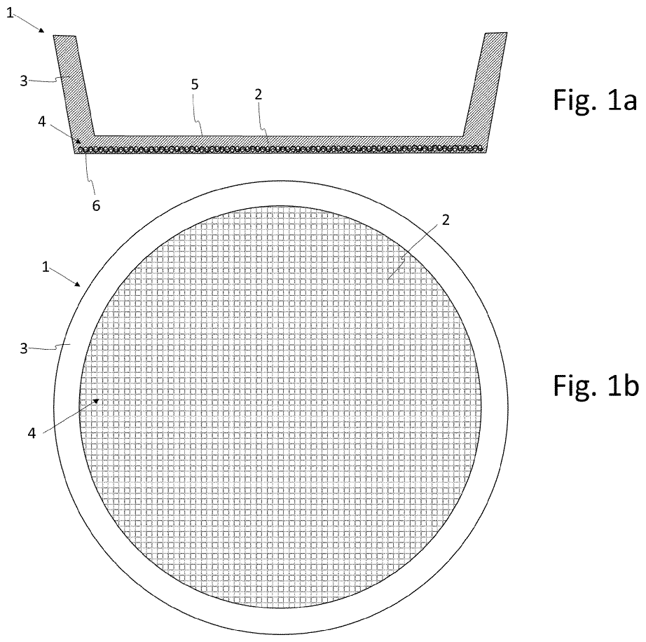

FIG. 1a and FIG. 1b depict an induction capable cookware item (1) according to an embodiment of the invention.

FIG. 1a provides a cross-section of the cookware item (1), wherein the cross-section is made perpendicular to the base (1) and trough the side wall (3), extending upwards form the base (2). A woven wire mesh (4) is encased in the base (2) of the cookware item (1). The base (2) and the side wall (3) form a vessel, thereby defining an interior side (5) and an exterior side (6).

FIG. 1b provides a bottom view of the cookware item (1), depicting the base (2) and the side wall (3). The presence of the woven wire mesh (4) is indicated by the dotted lines; however, the woven wire mesh (4) is completely encased in the base (2).

### Example 2

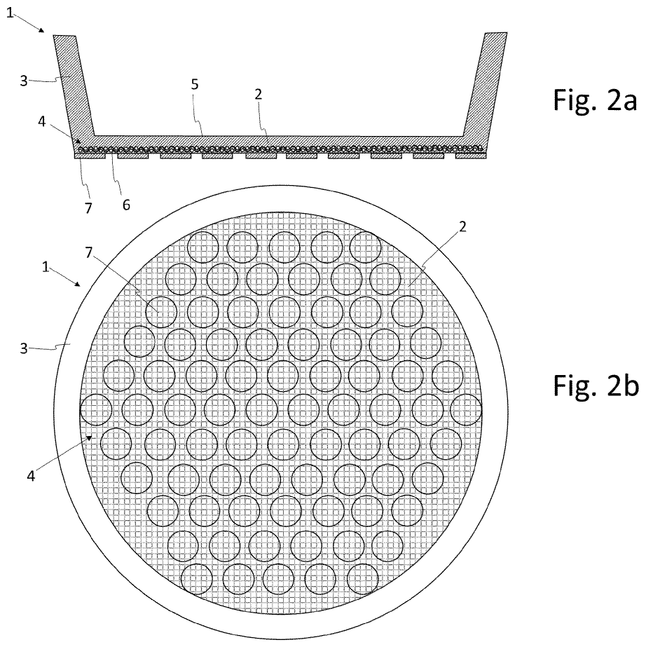

FIG. 2a and FIG. 2b depict an induction capable cookware item (1) according to an embodiment of the invention.

FIG. 2a provides a cross-section of the cookware item (1), wherein the cross-section is made perpendicular to the base (1) and trough the side wall (3), extending upwards form the base (2). A woven wire mesh (4) is encased in the base (2) of the cookware item (1). The base (2) and the side wall (3) form a vessel, thereby defining an interior side (5) and an exterior side (6). On exterior side (6) of the base (2), protrusions (7) are arranged in a pattern. The protrusions (9) are cylindrical, with a height far smaller than the diameter of the protrusion (cylinder).

FIG. 2b provides a bottom view of the cookware item (1), depicting the base (2) and the side wall (3). The presence of the woven wire mesh (4) is indicated by the dotted lines; however, the woven wire mesh (4) is completely encased in the base (2). The protrusions (7) on the base (2) project toward the viewer.

Both FIG. 2a and FIG. 2b show that the average cross-section of the protrusions (7) is larger than the average opening in the woven or knitted wire mesh (4). The average cross-section of the protrusions (7) is larger than at least four 2D repetitive units of the woven or knitted wire mech (4). This has the advantage that each protrusion (7) comprises or covers more than one repetitive unit of the woven or knitted wire mesh (4), resulting in a good heat production and heat transfer within the protrusion (7), on inductions heat plates.

In other embodiments not shown here, the average cross-section of the protrusions (7) is at least larger than the average opening in the woven or knitted wire mesh (4). In those embodiments, the average cross-section of the protrusions (7) is larger than at least 2, preferably at least 3, preferably at least 4, preferably at least 5, preferably at least 6, preferably at least 7, preferably at least 8, preferably at least 9 2D repetitive units of the woven or knitted wire mech (4).

Although not shown, it is possible for each protrusion to comprise more than one repetitive unit of the woven or knitted wire mesh.

### Example 3

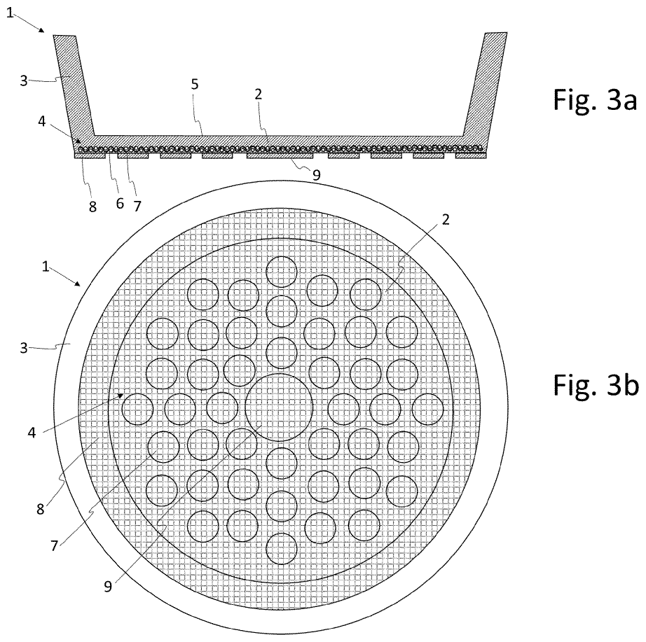

FIG. 3a and FIG. 3b depict an induction capable cookware item (1) according to an embodiment of the invention.

FIG. 3a provides a cross-section of the cookware item (1), wherein the cross-section is made perpendicular to the base (1) and trough the side wall (3), extending upwards form the base (2). A woven wire mesh (4) is encased in the base (2) of the cookware item (1). The base (2) and the side wall (3) form a vessel, thereby defining an interior side (5) and an exterior side (6). On exterior side (6) of the base (2), protrusions (7) are arranged in a pattern, inside a ring (8) along the edge of the base (2) and around a central protrusion (9). The protrusions (9) are cylindrical, with a height far smaller than the diameter of the protrusion (cylinder). The central protrusion (9) is also cylindrical, with a diameter far larger than the diameter of the other protrusions.

FIG. 3b provides a bottom view of the cookware item (1), depicting the base (2) and the side wall (3). The presence of the woven wire mesh (4) is indicated by the dotted lines; however, the woven wire mesh (4) is completely encased in the base (2). The protrusions (7), ring (8) and central protrusion (9) on the base (2) project toward the viewer.

Both FIG. 3a and FIG. 3b show that the average cross-section of the protrusions (7, 9) is larger than the average opening in the woven or knitted wire mesh (4). The average cross-section of the protrusions (7) which are arranged in a pattern, is larger than at least four 2D repetitive units of the woven or knitted wire mech (4). Additionally, the cross-section of the central protrusion (9) is larger than the average opening in the woven or knitted wire mesh (4) and the cross-section of the central protrusion (9) is larger than at least nine 2D repetitive units of the woven or knitted wire mech (4). This has the advantage that each protrusion (7, 9) comprises or covers more than one repetitive unit of the woven or knitted wire mesh (4), resulting in a good heat production and heat transfer within the protrusion (7, 9), on inductions heat plates.

In other embodiments not shown here, the average cross-section of the protrusions (7, 9) is at least larger than the average opening in the woven or knitted wire mesh (4). In those embodiments, the average cross-section of the protrusions (7, 9) is larger than at least 2, preferably at least 3, preferably at least 4, preferably at least 5, preferably at least 6, preferably at least 7, preferably at least 8, preferably at least 9 2D repetitive units of the woven or knitted wire mech (4).

Although not shown, it is possible for each protrusion (7, 9) to comprise more than one repetitive unit of the woven or knitted wire mesh (4).

In the above examples, the base (2) has been depicted to be straight. However, the skilled person understands that the base (2) in all examples can also be concave (viewed from the exterior side). In other words, the base might be hollow.

### Example 4

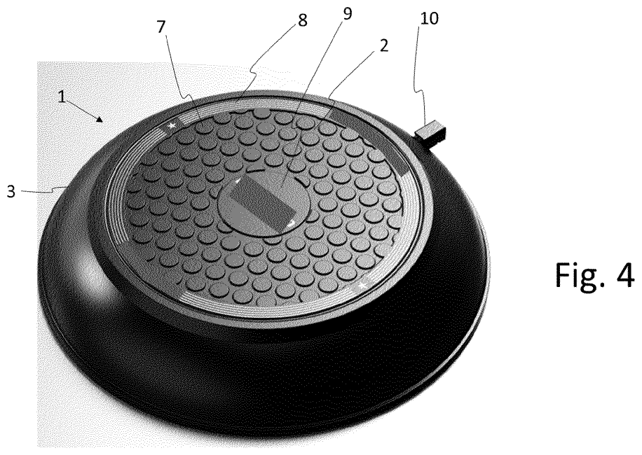

FIG. 4 provides a render of an induction capable cookware item (1) according to an embodiment of the invention. The elements of the cookware item are comparable to the elements of the cookware item in example 3. In Example 4, the woven wire mesh is completely embedded in the aluminium base (2), and hence not visible in FIG. 4. The woven wire mesh has a diameter of 200 mm and in made from 0.5 mm AISI 430 wire, and is double crimped. It has an open weave with square openings of 1 mm by 1 mm. The diameter of the base is 220 mm, and the diameter of the vessel formed by the side wall (3) and the base (2) is 280 mm. The thickness of the base is 4.0 mm. The diameter of the protrusions (7) are 10 mm. The ring (8) has a width of 9.5 mm. the diameter of the central protrusion (9) is 48 mm. The protrusions (7), the ring (8) and the central protrusion (9) all have a height of 0.8 mm. A handle (10) is attached to the side wall (3).

1. An induction capable cookware item, comprising:
a base, mainly made from aluminium or an aluminium alloy;
a side wall, extending upwards from said base;
wherein the base and the side wall form a vessel, thereby defining:
an exterior side of the vessel, the base and the side wall; and,
an interior side of the vessel the base and the side wall;
wherein the base comprises a woven wire mesh or knitted wire mesh, preferably a woven wire mesh; and,
wherein the base comprises protrusions on the exterior side.

2. The cookware item according to claim 1, wherein the average cross-section of the protrusions is larger than the average opening in the woven or knitted wire mesh.

3. The cookware item according to claim 1, wherein the woven or knitted wire mesh is completely encased by the base, preferably wherein the woven or knitted wire mesh is completely encased by the aluminium or the aluminium alloy of the base.

4. The cookware item according to claim 1, comprising:
a base, mainly made from aluminium or an aluminium alloy;
a side wall, mainly made from aluminium or an aluminium alloy; and extending upwards from said base;
wherein the base comprises a woven wire mesh or a knitted wire mesh; preferably a woven wire mesh, preferably a woven or knitted ferrous metal wire mesh, preferably a woven or knitted steel wire mesh.

5. The cookware item according to claim 1, wherein the woven wire mesh is crimped woven wire mesh, preferably double crimped woven wire mesh.

6. The cookware item according to claim 1, wherein the woven wire mesh is an open weave.

7. The cookware item according to claim 1, wherein the average opening in the weave is larger than, preferably least 2.0 times larger than, preferably least 3.0 times larger than, preferably least 4.0 times larger than, preferably least 5.0 times larger than the cross-section of the wire.

8. The cookware item according to claim 1, wherein the cookware item is forged.

9. The cookware item according to claim 1, wherein the protrusions are aluminium or aluminium alloy protrusions.

10. The cookware item according to claim 1, wherein the protrusions are circular, spherical caps, spherical segments or cylindrical, preferably cylindrical.

11. The cookware item according to claim 1, wherein the height of the protrusions is less than the diameter of the protrusion.

12. The cookware item according to claim 1, wherein the average cross-section of the protrusions is larger than two times the average opening in the woven or knitted wire mesh.

13. The cookware item according to claim 1, wherein the woven or knitted wire mesh extends throughout at least 50%, preferably at least 60%, preferably at least 70%, preferably at least 80%, preferably at least 90%, preferably at least 95%, preferably at least 98%, preferably at least 99% of surface area of the base.

14. A method for manufacturing an induction capable cookware item, comprising the steps of:
providing an aluminium or aluminium alloy disk with a first diameter (d1);
providing a disk of a woven or knitted wire mesh, preferably a disk of a woven wire mesh, with a second diameter (d2), wherein the second diameter is smaller than the first diameter (d2<d1);
concentrically aligning the aluminium or aluminium alloy disk and the disk of woven or knitted wire mesh over a cookware mould;
forging the aligned aluminium or aluminium alloy disk and the disk of woven or knitted wire mesh in the mould, thereby:
forming a cookware item comprising a base and a side wall extending upwards from the base; and,
integrating the woven or knitted wire mesh completely in the base, preferably completely in the aluminium or aluminium alloy of the base.

15. A cookware item comprising an induction element in its base, wherein the induction element comprises a crimped woven wire mesh, preferably a double crimped woven wire mesh.

16. The cookware item of claim 15, wherein the wire of the woven wire mesh is a ferrous metal.
